(19) United States
(12) Patent Application Publication
(10) Pub. No.: US 2005/0216332 A1
(43) Pub. Date: Sep. 29, 2005

(54) Voter registration and election management

(76) Inventor: Tracy N. Lewin, Fayette, AR (US)

Correspondence Address: FISH & RICHARDSON PC, P.O. BOX 1022, MINNEAPOLIS, MN, 55440-1022, US

(21) Appl. No.: 11/055,552

(22) Filed: Feb. 9, 2005

Related U.S. Application Data
(60) Provisional application No. 60/544,869, filed on Feb. 13, 2004.

(51) Int. Cl. G06F 17/60

(52) U.S. Cl. 705/12

(57) ABSTRACT

Methods and systems, including computer program products, implementing techniques for administering election-related information. The techniques include storing election-related information including information associated with voters in a first governmental unit, and election-related configuration data each associated with particular ones of a plurality of constituent governmental units within the first governmental unit; and providing a plurality of interfaces to the election-related information, each interface associated with a different one of the constituent governmental units.

### CROSS-REFERENCE TO RELATED APPLICATIONS

This application claims priority based on U.S. Provisional Patent Application Ser. No. 60/544,869 for “Voter Registration and Election Management” filed Feb. 13, 2004, the disclosure of which is incorporated herein by reference in its entirety.

### BACKGROUND

This description relates to voter registration and election management.

Currently, state and federal elections in many states are conducted in a manner that can be thought of as a partnership between the state and the municipalities. For example, elections in a United States (U.S.) state are conducted in accordance with applicable U.S. federal and state laws, as well as the state constitution. However, individual counties, municipalities and precincts are responsible for the actual collection of registration data and maintenance of official voter registration lists. These lists are often maintained separately in a variety of disparate formats, including handwritten, typed, and computerized lists.

The U.S. Help America Vote Act of 2002 (HAVA) is election reform legislation that seeks to enhance the integrity of the elections process by establishing certain minimum standards for the conduct of federal elections. HAVA mandates changes to numerous parts of the voting process, including a requirement that each state develop, implement and manage a computerized statewide voter registration list as described in HAVA §303(a).

Elections in other countries also require various aspects of coordination between different levels of government.

### SUMMARY OF THE INVENTION

In a general aspect, the invention provides a method and apparatus, including a computer program product, implementing techniques for developing and managing a statewide voter registration and election management system that is configurable to each state's laws, regulations and/or policies, as well as to those of individual constituent county, municipal, and/or precinct units. The system may include a configurable user interface, intelligent workflow management, enhanced navigation, dynamic reporting capabilities, and instant data view and easy data manipulation. The system provides statewide standardization of election data with local flexibility.

In one aspect, the invention features a system for administering election-related information. The system includes a data storage system for storing information associated with voters in a first governmental unit and for storing election-related configuration data each associated with particular ones of a plurality of constituent governmental units within the first governmental unit; and a plurality of interface components each associated with a different one of the constituent governmental units, wherein each of the interface components provides access to the stored information according to election-related configuration data associated with that governmental unit.

Implementations may include one or more of the following. The first governmental unit includes a state within a nation, and the constituent governmental units include counties within the state. The election-related configuration data includes election-related rules. The election-related rules include computer instructions for implementing the rules within the data storage system. The governmental unit and the constituent governmental units are arranged in a tree structure of nodes. At least one constituent governmental unit inherits one or more election-related rules from its parent node.

The interface components are distributed separate from the data storage system. The interface components are centrally hosted with the data storage system. Each of the interface components includes a rules processing engine for processing election-related rules for the governmental unit with which the interface component is associated. The system includes three or more tiers, including a user tier, a business tier, and a data tier.

Each of the interface components is configured to maintain voter registration information in the data storage system for voters associated with the governmental unit with which the interface component is associated. The system includes an administration system for processing information for voters associated with multiple of the constituent governmental units. Processing the information for the voters includes identifying conflicts in the stored information associated with different of the constituent governmental units. Processing the information for the voters includes transferring stored information associated with one constituent governmental unit to be associated with another of the constituent governmental units. Processing the information for the voters includes transferring stored information associated with a governmental unit to be associated with constituent units of that governmental unit.

In another aspect, the invention features a method for administering election-related information. The method includes storing election-related information and providing a plurality of interfaces to the election-related information. The election-related information includes information associated with voters in a first governmental unit, and election-related configuration data each associated with particular ones of a plurality of constituent governmental units within the first governmental unit. Each interface is associated with a different one of the constituent governmental units.

Implementations may include one or more of the following. The method further includes accessing the information associated with the voters in the first governmental unit according to the election-related configuration data associated with the governmental units. The method further includes receiving a request from a user to access a portion of the information associated with the voters in the first governmental unit; determining, according to the election-related configuration data, whether the user is permitted to access the user-requested portion of the information, and if so, providing the user-requested portion of the information to an interface associated with the user. The user-requested portion of the information is provided to the interface in one or more segments, each segment comprising a distinct subset of the user-requested portion of the information.

In another aspect, the invention features a system that includes a client, a server, and a collection of data, and a method for providing a multi-tier application that provides data from the collection of data in a plurality of segments. The method includes at the client, receiving a request from a user to access a portion of the collection of data, processing the user request to form a plurality of page requests, and sending each page request to the server; and at the server, querying the collection of data in response to each page request to retrieve a segment of the user-requested portion of the collection of data, and providing each retrieved segment to the client, each retrieved segment comprising a distinct subset of the user-requested portion of the collection of data. Each page request can sent to the server on an as-needed basis.

Aspects of the invention have one or more of the following advantages. The system provides statewide functionality through the use of a centralized database of voter records. In this manner, voter records may be searched across multiple jurisdictions using a single system. This eliminates duplicate records and may combat voter fraud. The system provides integrated state and county election management functionality. In this manner, contests, candidate, petitions and election calendars may be entered once at a state-level. This eliminates the need for statewide entries to be entered by individual counties, municipalities or precincts, thus reducing duplicate efforts and minimizing the likelihood of errors. The system provides a database paging technique for retrieving large datasets without maintaining an expensive, continuous database connection. This further minimizes the likelihood the network or database may be overloaded.

### BRIEF DESCRIPTION OF THE DRAWINGS

FIG. 1 shows a block diagram of a communication system.

### DETAILED DESCRIPTION

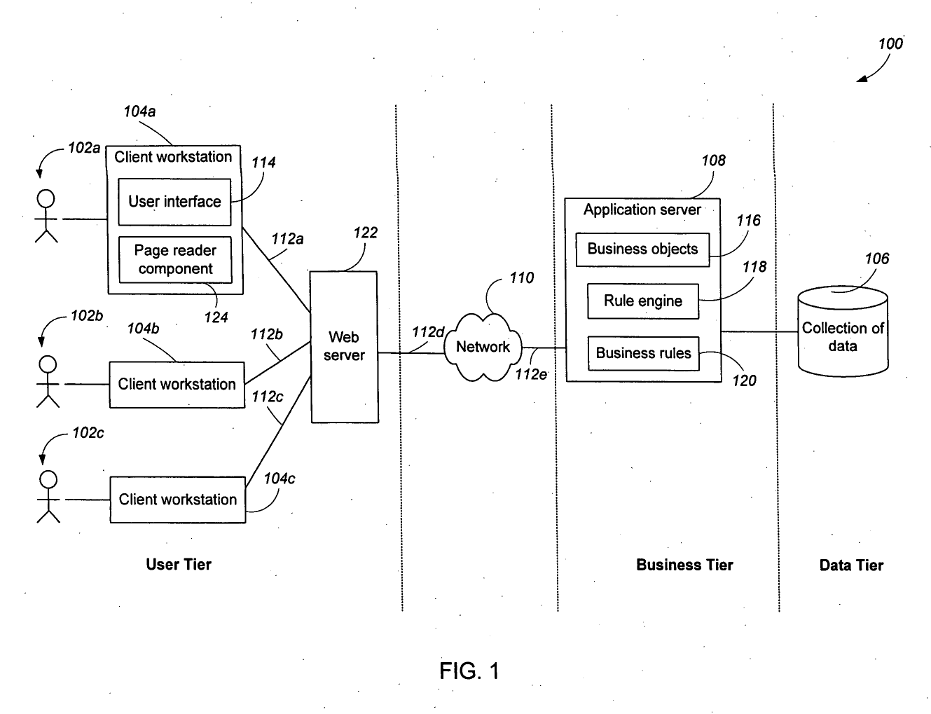

Referring to FIG. 1, a system 100 is used by multiple users 102, including respective first, second and third users 102a, 102b and 102c, at client workstations 104, including corresponding first, second and third workstations 104a, 104b and 104c. Each user 102 can access a collection of data 106 through an application server 108 across a network 110 using communication links 112a, 112b, 112c and/or 112d. Furthermore, each of the users 102 can modify some or all of the data included in the collection of data 106.

In one implementation, the system 100 includes a three-tier voter registration and election management application for administering election-related information. The application includes multiple distinct logical components that interact with one another. Examples of such logical components include a data storage component for storing election-related information and one or more interface components for providing access to the election-related information.

In the example illustrated in FIG. 1, the data storage component and the interface component(s) are physically and/or software architecturally distributed over the three tiers of the application, namely a user tier, a business tier, and a data tier. The user tier presents, on the workstations 104, a user interface 114 for the application, displays data and collects user input. The user tier also sends requests for data to the business tier, which resides at the application server 108. The business tier has business objects 116 and a rule engine 118 that implement the business rules 120 (e.g., election-related configuration data) for the application. As the business objects 116 and the business rules 120 are separate components within the business tier of the application, modifications and/or additions to the business rules 120 may be made without any need to modify the business objects 116 that invoke the business rules 120 or recompile the application logic within the business objects 116. This middle tier receives requests for data from the user tier, uses the business objects 116 to evaluate the data against the business rules 120, and passes them on to the data tier, which includes the collection of data 106. The business tier then receives data from the data tier and passes this back to the user tier. The data tier communicates directly with the collection of data 106 and passes data between the data store and the business tier.

Although the tiers of the application are depicted as residing on different machines, other implementations may be used, e.g., the data storage component including the business rules 120 (data tier) and the collection of data 106 (business tier) physically reside on one machine, while an interface component including the user interface 114 (user tier) and business objects 116 (business tier) physically resides on another machine.

One example of the type of data included in the collection of data 106 is a voter database for a state. The voter database includes data for all the registered voters in the state, for example, by including a voter record for each registered voter in the state. Each voter record includes the name of a registered voter, and generally includes further information, such as personal (e.g., place of birth and social security number) and demographic (e.g., age, sex and race) information for the registered voter, voter status (e.g., party affiliation) and voter activity (e.g., date registered and date last voted). The collection of data 106 can be structured in a number of alternative ways, such as using a database system that may include a database management system, a relational database, a distributed database, or other similar structure.

Generally, when a user 102 performs a task (e.g., adding a voter record, modifying a voter record, creating a voter report), a request for data first goes to a web server 122 residing on the user tier. The web server 122 directs the request to the application server 108 on the business tier to be processed. In processing the request, the application server 108 may query data from the collection of data 106 in the data tier.

Suppose, for example, that the user 102a wants to create a voter report that provides a list of all of the registered voters in a county having 1 million registered voters, as well as their residential address. The application may be configured to launch a “Report Generator” wizard that displays a wizard page on the user interface 114 at the workstation 104a in response to a user request to create a voter report. The user 102a enters the relevant information in the wizard page (e.g., the user 102a selects data fields “Name” and “Residential Address”) and clicks on an “OK” button displayed on the wizard page. The wizard generates a request for 1 million voter records. Rather than sending the wizard request for 1 million voter records directly to the web server 122, a page reader component 124 in the user tier of the application may be configured to process the wizard request to form multiple page requests (e.g., for 1000 voter records per page request), and sending each page request to the application server 108 (through the web server 122). In this manner, in processing each request received from the user tier, the application server 108 queries the collection of data 106 in the data tier for segments of the voter records, e.g., 1000 voter records rather than 1 million voter records at a time. This minimizes the likelihood that the network 110 or the application server 108 may become overloaded when processing requests from the user tier.

For ease of description, the term “current page” refers to the page of voter records that are being consumed by the user tier of the application at a particular time, and the term “next page” refers to the page of voter records including voter records directly following the voter records of the current page.

In one implementation, the page reader component 124 retrieves pages of voter records on an as-needed basis by monitoring the consumption of the current page of voter records by the wizard, and generating a new page request (i.e., for the next page of voter records) when the current page is consumed beyond a predetermined threshold level. The results of the new page request that are returned from the collection of data 106 (via the application server 108) are stored in a buffer maintained by the page reader component 124. From the perspective of the wizard, the requested data is provided on a continuous basis by the page reader component 124 as though all of the wizard requested voter records were returned in response to the single wizard request.

The application provides a user 102 access to the collection of data 106 based on election-related configuration data, which includes business rules 120 for handling voter records with different attributes and preferences for particular users based on the user's role 124. Such business rules 120 are also referred to in this description as “election-related rules”. In general, the system 100 supports a hierarchy of governmental units, for example with a single state at the top level, a number of counties at the next level, and a number of municipalities at the next level. Other types of governmental units can also be supported, such as federal election districts, municipal precincts, etc. The data representing the inter-relationship of these constituent governmental units (also referred to as “sites”) can be arranged in a tree structure site hierarchy.

A user's role may be determined by the level of or the particular governmental unit with which that user is associated. The site hierarchy represents the different levels of government within a state, for example, state-level, county-level, municipality-level, and precinct-level. In one implementation, the ordering of the sites in the site hierarchy goes from most general (i.e., state-level) to least general (i.e., precinct-level). A predefined set of election-related rules can be applied to the most general site, which in this case is the state-level site. The rule engine 114 in the business tier of the application can be configured such that each site inherits the rules from its parent (e.g., county-level site inherits rules that apply to the state-level site). Each site can further include one or more local election-related rules that are only called by another rule at that same site. Such local election-related rules are typically non-inheritable.

The application also allows for multiple levels of security and permissions depending on the role of the user. For example, the application can be configured to authorize a user associated with a state-level site to change a county's districts, while a user associated with a county-level site is not authorized to change a state-level site function (e.g., changing a state-wide contest). The security and permissions per role can be varied to provide great flexibility, for example, a user associated with county A can process a mailed-in absentee application for a voter registered in county B. The application can also be configured to allow a user associated with county A to automatically forward an absentee (or voter registration) application to a person residing in county B.

Depending on the role of a user, the user can modify and/or add a voter record to the collection of data 106. Suppose, the user 102a (who is associated with county A) submits a voter record for “John Andrew Smith” for addition to the collection of data 106. The business tier of the application can be configured to compare the submitted voter record with the voter records currently in the collection of data 106 to identify conflicts, e.g., by determining whether the newly-submitted voter record is a duplicate of an existing voter record (i.e., a voter record already exists for “John Andrew Smith” in county B). If so, the application can be configured to automatically modify the voter record to reflect the change in county and take some action, such as alert the user 102b (who is associated with county B) of the change.

Depending on the role of a user, the user 102c (who is associated with the state) can set up statewide elections by submitting the appropriate information (e.g., name of candidate, office, party affiliation) to the application server 108 which then propagates the information to the other sites in the site hierarchy. In this manner, the information for a statewide election need only be entered once at the state-level rather than multiple times at the county/municipal/precinct-level by each user 102a and 102b associated with a county.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed three-tiered computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Other embodiments are within the scope of the following claims. The following are examples for illustration only and not to limit the alternatives in any way. The techniques described herein can be performed in a different order and still achieve desirable results. For example, although the system 100 has been described with reference to a governmental hierarchy that includes a state, counties, municipalities, and precincts, the system 100 may also be used as a voter registration and election management system for governmental hierarchies that include fewer or other governmental units. Although described in the context of a voter registration and election management application, both the rules engine 118 and the page reader component 124 can stand alone as separate components for any software application implemented using an architectural model similar to that shown in FIG. 1.

1. A system for administering election-related information comprising:
a data storage system for storing information associated with voters in a first governmental unit and for storing election-related configuration data each associated with particular ones of a plurality of constituent governmental units within the first governmental unit; and
a plurality of interface components each associated with a different one of the constituent governmental units, wherein each of the interface components provides access to the stored information according to election-related configuration data associated with that governmental unit.

2. The system of claim 1 wherein first governmental unit comprises a state within a nation.

3. The system of claim 2 wherein the constituent governmental units comprise counties within the state.

4. The system of claim 1 wherein the election-related configuration data includes election-related rules.

5. The system of claim 4 wherein the election-related rules include computer instructions for implementing the rules within the data storage system.

6. The system of claim 1 wherein the governmental unit and the plurality of constituent governmental units are arranged in a tree structure of nodes.

7. The system of claim 6 wherein at least one constituent governmental unit inherits one or more election-related rules from its parent node.

8. The system of claim 1 wherein the interface components are distributed separate from the data storage system.

9. The system of claim 1 wherein the interface components are centrally hosted with the data storage system.

10. The system of claim 1 wherein each of the interface components includes a rules processing engine for processing election-related rules for the governmental unit with which the interface component is associated.

11. The system of claim 1 wherein the system comprises a user tier, a business tier, and a data tier.

12. The system of claim 1 wherein each of the interface components is configured to maintain voter registration information in the data storage system for voters associated with the governmental unit with which the interface component is associated.

13. The system of claim 1 further comprising an administration system for processing information for voters associated with multiple of the constituent governmental units.

14. The system of claim 13 wherein processing the information for the voters includes identifying conflicts in the stored information associated with different of the constituent governmental units.

15. The system of claim 13 wherein processing the information for the voters includes transferring stored information associated with one constituent governmental unit to be associated with another of the constituent governmental units.

16. The system of claim 13 wherein processing the information for the voters includes transferring stored information associated with a governmental unit to be associated with constituent units of that governmental unit.

17. A method comprising:
storing election-related information including:
information associated with voters in a first governmental unit, and
election-related configuration data each associated with particular ones of a plurality of constituent governmental units within the first governmental unit; and
providing a plurality of interfaces to the election-related information, each interface associated with a different one of the constituent governmental units.

18. The method of claim 17, further comprising accessing the information associated with the voters in the first governmental unit according to the election-related configuration data associated with the governmental units.

19. The method of claim 17, further comprising:
receiving a request from a user to access a portion of the information associated with the voters in the first governmental unit;
determining, according to the election-related configuration data, whether the user is permitted to access the user-requested portion of the information, and if so, providing the user-requested portion of the information to an interface associated with the user.

20. The method of claim 19, wherein the user-requested portion of the information is provided to the interface in one or more segments, each segment comprising a distinct subset of the user-requested portion of the information.

21. In a system that includes a client, a server, and a collection of data, a method for providing a multi-tier application that provides data from the collection of data in a plurality of segments, the method comprising:
at the client, receiving a request from a user to access a portion of the collection of data, processing the user request to form a plurality of page requests, and sending each page request to the server; and
at the server, querying the collection of data in response to each page request to retrieve a segment of the user-requested portion of the collection of data, and providing each retrieved segment to the client, each retrieved segment comprising a distinct subset of the user-requested portion of the collection of data.

22. The method of claim 21, wherein each page request is sent to the server on an as-needed basis.
